(19) United States
(12) Patent Application Publication
(10) Pub. No.: US 2013/0159191 A1
(43) Pub. Date: Jun. 20, 2013

(54) METHOD AND SYSTEM FOR LIMITING RISK IN BANKING TRANSACTIONS

(71) Applicants: Rajashekara Visweswara Maiya, Karnataka (IN); Sachindran Kunjumpidukkal, Kerala (IN); Manjunath Dindukurthi Viswanath, Andhra Pradesh (IN)

(72) Inventors: Rajashekara Visweswara Maiya, Karnataka (IN); Sachindran Kunjumpidukkal, Kerala (IN); Manjunath Dindukurthi Viswanath, Andhra Pradesh (IN)

(73) Assignee: INFOSYS LIMITED, Bangalore, Karnataka (IN)

(21) Appl. No.: 13/819,379

(22) PCT Filed: Aug. 30, 2010
(86) PCT No.: PCT/IN10/00570

§ 371 Date: Feb. 27, 2013

(51) Int. Cl. G06Q 20/40

(52) U.S. Cl. CPC G06Q 20/4016
USPC 705/44

(57) ABSTRACT

A system and method for processing banking transactions in risk limit mode when connectivity to a central application server is unavailable. The method includes calculating available balance in customer account associated with current transaction and determining if current transaction amount is less than the available balance. In case the current transaction amount is less than the available balance, a total amount associated with transactions for a plurality of customer accounts executed in risk limit mode is calculated. Thereafter, if it is determined that the total calculated transaction amount is less than a pre-defined risk limit value for a customer, the current transaction is allowed. Otherwise, the current transaction is rejected.

### FIELD OF INVENTION

The present invention relates generally to the field of banking transactions. More particularly, the present invention implements a system for providing reduced risk in banking transactions in event of failure of a primary transaction server.

### BACKGROUND OF THE INVENTION

Due to an increase in the number and range of banking services provided to customers by banking services providers in recent times, the use of Information Technology (IT) in the provision of services has become more pronounced. For providing enhanced customer satisfaction, in addition to basic services such as credit and debit transactions, electronic services such as interne banking, mobile banking, customer relationship based banking, ATM banking are increasingly being included by banking service providers and financial institutions. Inclusion of complementary electronic services in addition to basic services ensures that banks are in a position to serve customers on a 24 by 7 by 365 basis.

Typically, banking services providers employ a centralized implementation wherein multiple banking services are provided to customers from a central location housing a primary server. Thus, customers at a central location as well as at local branches are serviced through the primary server and an associated central database. However, the primary server at the central location is complemented by a standby server that manages operations in the instance of the primary server being unavailable for maintenance purposes or during End of Day processing. There might be scenarios when connectivity between primary server or central standby server with local branches is inoperative due to various reasons.

Thus, there exists a need for a system and method to provide uninterrupted services to local branch customers without compromising on customer and data security.

### SUMMARY OF THE INVENTION

A system and method for providing banking solutions by limiting risk in provision of one or more banking services to customers of a banking services provider is provided. The system includes central application server comprising a primary software application configured to provide the one or more banking services to direct customers of the central facility and to customers of one or more local branches. The system further includes a central stand-in server configured to provision the one or more banking services to customers during End of Day processing.

In various embodiments of the present invention, the system includes a connector application configured to interface the central application server with a plurality of delivery channels and a plurality of electronic applications, and a web server configured to enable customers of the banking services provider to access the one or more banking services through the central application server.

In various embodiments of the present invention, the system of the invention includes one or more local stand-in servers installed at the one or more local branches for provisioning the one or more banking services to customers of the one or more local branches when connectivity between the one or more local branches and the central application server and between the one or more local branches and the central stand-in server is unavailable. The one or more local stand-in servers provide the one or more banking services by implementing risk limiting logic, wherein risk limiting logic is implemented by utilizing an allocated risk limit value corresponding to each customer while authorizing banking transactions.

In various embodiments of the present invention, the system of the present invention includes an integrator module configured to operate as a transaction gateway for integrating primary software application of the central application server with one or more value-added services. The one or more value-added services comprises internet banking, mobile banking, real-time advisement services, audio/video customer support, co-browsing services, alert notification services and customer relationship management services.

In various embodiments of the present invention, the system of the present invention includes a central database configured to store customer data including customer transactional data and customer profile data, a central stand-in server database configured to store copy of customer transactional data and customer profile data continuously updated by automatic streaming.

In various embodiments of the present invention, each local branch includes a branch application server hosting a primary application configured to service direct customers of the branch, a branch database operationally linked to the branch application server and comprising customer data pertaining to the local branch and a local stand-in server configured to operate in a risk limit mode for servicing local branch requests when connectivity between the local branch and the central application server is unavailable.

In various embodiments of the present invention, the system of the present invention may include a flexi stand-in server in lieu of the one or more local stand-in servers for servicing requests pertaining to the one or more local branches.

In various embodiments of the present invention, the central application server implements one or more software processes for provisioning one or more banking services to customers. The one or more software processes includes a uniserver process configured to manage business functionality of messages delivered by one or more of the plurality of delivery channels and the plurality of electronic applications to the central application server, a listener process configured to accept connections from processes running in the central stand-in server and the one or more local stand-in servers, a cron service configured to keep a contra entry record of cash amount withdrawals from ATMs and point of sale terminals and continuously providing updated information to a central database of the central application server and a replication send service that identifies records updated or added in the central database and provides the information to a listener process in the central stand-in server.

In various embodiments of the present invention, the method includes the following steps: calculating available balance in customer account associated with current transaction, determining if current transaction amount is less than the available balance and calculating total amount associated with transactions for a plurality of customer accounts executed in risk limit mode, if the current transaction amount is less than the available balance. Further, the method includes determining if total calculated transaction amount is less than a pre-determined risk limit value pre-defined for a customer and allowing current transaction if total calculated transaction amount is less than the pre-determined risk limit value.

In various embodiments of the present invention, the method includes rejecting current transaction if the current transaction amount is more than available balance in customer account associated with current transaction. Further, the method includes rejecting current transaction if the total calculated transaction amount is more than the pre-determined risk limit value.

### BRIEF DESCRIPTION OF THE ACCOMPANYING DRAWINGS

The present invention is described by way of embodiments illustrated in the accompanying drawings wherein:

FIG. 1 depicts software architecture implemented by a banking services provider for providing banking services, in accordance with an embodiment of the present invention;

FIG. 2 illustrates interaction of software components deployed at a local branch with central application server of a banking services provider for servicing branch level requests;

FIG. 3 illustrates messaging between software components of a central facility of a banking services provider and components of IT system of a local branch for providing transaction services;

FIG. 4 illustrates implementation of various modes of operation by a banking system for servicing transaction requests, in accordance with an embodiment of the present invention; and

FIGS. 5A and 5B illustrates method steps for processing a transaction request in risk limit mode.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

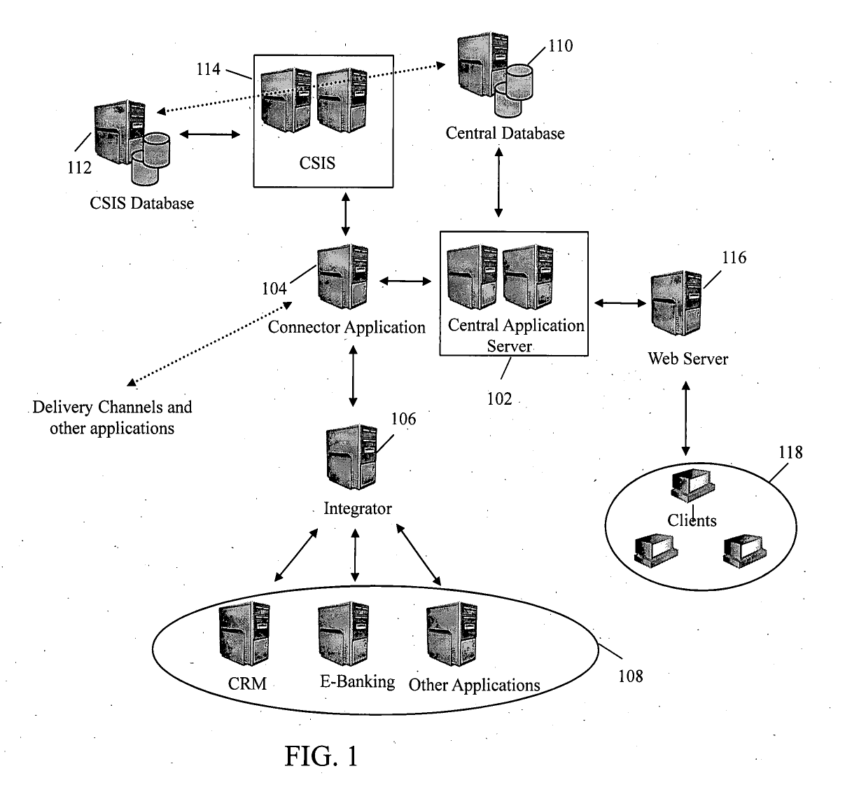

FIG. 1 depicts software architecture implemented by a banking services provider for providing banking services, in accordance with an embodiment of the present invention. The software architecture includes a central application server 102 comprising a primary software application configured to provide banking solutions to customers as well as internal clients. The primary software application comprises executable files having business logic for running various processes implementing banking solutions. Further, the primary software application includes logic for implementing solutions in addition to basic banking services (account transactions which are usually offered to customers). Additional services enabled by the primary software application of the central application server 102 may include, but are not limited to, internet banking, mobile banking, real-time advisement and account access services, audio/video customer support, co-browsing services, alert notification services etc. Solutions supported by the primary software application may also include Customer Relationship Management (CRM) solutions. CRM solutions enable banking service providers to differentiate customers based on customer segmentation, business support provided, potential available for business growth, social status etc. and then provide value-added supplementary services based on the differentiation. Such value-added supplementary services are investment banking solutions, context-sensitive transactions, customized illustrations of financial products etc. Further, software architecture of the present invention offers one or more applications that can be used by banks and financial institutions to facilitate the provision of such value-added supplementary services. Applications that facilitate provision of value-added services may include, but are not limited to, customer data modeling and analytics, customer relationship analysis, transaction behavior analysis, individual report generation, cross selling and product holding analysis etc. Such applications that facilitate the provision of value-added services may be used by employees of banks and financial institutions.

For the purpose of providing the aforementioned applications and services, the central application server 102 is configured to link with multiple software modules through a connector application 104. The connector application 104 is a real-time interface that integrates the central application server 102 with multiple service delivery channels such as Automated Teller Machines (ATMs), treasury applications, telebanking, call center, e-banking etc. Moreover, the connector application 104 also integrates the central application server 102 with value-added service applications, such as CRM, e-banking, customer analytics through an integrator 106. In an embodiment of the present invention, the integrator 106 is a Java 2 Platform Enterprise Edition (J2EE) component that acts as transaction gateway between the connector application 104 and value-added service applications. As shown in the figure, the integrator 106 is linked to one or more applications 108 using web services. In an embodiment of the present invention, the one or more applications 108 may be CRM services, E-banking services or other value-added services. Thus, the connector application 104 acts as middleware for real time interface of primary software application of the central application server 102 either with delivery channels or with other applications. In an embodiment of the present invention, delivery channels and the one or more applications 108 are browser based and can be accessed using web services. In an embodiment of the present invention, the connector application 104 interacts with delivery channels and other service applications as well as the integrator 106 using an ISO 8583 protocol. ISO 8583 is a framework for creating protocols for exchange of financial transaction messages. For enabling one or more clients 118 to access banking applications offered by system of the present invention, the central application server 102 is operationally connected to a web server 116. Examples of the one or more clients 118 may include processing devices used by customers or by internal employees of banking services providers. The web server 116 delivers web pages related to banking services to the one or more clients 118, for example, the server delivers a login page to a web browser on a client computer used by a customer. The customer logs in and easily navigates through other web pages for accessing banking services. In an embodiment of the present invention, the central application server 102 services requests arriving through the web server 116 by communicating with delivery channels and other service applications via the connector application 104. In another embodiment of the present invention, the central application server 102 services requests arriving through the web server 116 by communicating with the one or more applications 108 via the connector application 104 and the integrator 106.

The web server 116 is configured to implement Single Sign-on framework. Single Sign-on (SSO) is a software framework used by customers to access multiple applications that are linked with the primary software application hosted by the central application server 102. Using SSO framework, clients and customers are authenticated for applications which they are authorized to access. The SSO framework also supports browser level integration of the one or more applications 108.

In various embodiments of the present invention, the connector application 104 employs a standard messaging architecture for facilitating data transfer between the central application server 102 and the one or more applications 108. An example of messaging standard that can be used is a Simple Object Access Protocol (SOAP) protocol. The connector application 104 supports Straight-Through-Processing for facilitating efficient data transfer between the central application server 102 and other components. Straight-Through-Processing is the execution of financial transactions between the one or more applications 108 and the one or more clients 118 without any manual intervention. Further, the connector application 104 interfaces to ‘Op-console’ to enable proactive and reactive system administration. Op-console is a messaging service that relays messages from one or more entities in the software architecture to an event viewer component of an operating system that displays the messages as event logs. In an embodiment of the present invention, a system administrator can view the event logs on a computing device and tale appropriate action. The connector application 104 is a multiplexed, multi-connection, asynchronous interface that is configured to implement load balancing with reference to service requests arriving at the central application server 102. Load balancing is a feature wherein, number of software processes deployed by a system for servicing requests is automatically adjusted by the system based on the number of requests. In an embodiment of the present invention, while configuring the connector application 104, a system administrator pre-specifies the maximum number of services to be brought up for supporting service requests also the minimum number of services that should be maintained by the connector application 104 at any point in time. As number of requests to the connector application 104 increase, the connector application 104 keeps on adding services required for servicing the requests. Once service load is reduced, extra services will be dropped automatically by the connector application 104, but it will be ensured that at least the minimum number of services specified by the system administrator is maintained at any point of time.

In an embodiment of the present invention, the central application server 102 is physically located within central facility of a banking services provider for servicing customers holding account with the central facility. Further, the central application server 102 is also configured to service customers having accounts with local branches in different geographical areas. As shown in the figure, the central application server 102 is connected to a central database 110. The central database 110 stores customer data including customer transactional data and customer profiles. In an embodiment of the present invention, the central database 110 comprises one or more database structures that contain definitions or schemas about how customer data is organized within the database. As illustrated in FIG. 1, the system of the present invention includes a Central Stand-in Server (CSIS) 114 that comprises business logic for servicing transaction requests whenever the central application server 102 is unable to service those requests.

In an embodiment of the present invention, the CSIS 114 and the Central Application Server 102 are physically linked with each other through a Local Area Network (LAN). Further, the Central database 110 is connected to a Central Stand-in Server (CSIS) database 112. In some scenarios, for maintenance purposes or during End of Day (EOD) processing, the central application server 102 may be out of operation and the CSIS application server 114 processes services requests. In various embodiments of the present invention, data on the CSIS server 114 includes snapshot of customer details such as account details and transaction details. Customer details are sent from the Central Database 110 to the CSIS database 112 at regular time intervals as automatic streaming updates and are provided by the CSIS database 112 to the CSIS application server 114, when required for processing transactions. In an embodiment of the present invention, streaming updates from the Central Database 110 to the CSIS Database 112 achieves synchronization of data between the two databases. “Automatic streaming updates” minimize cut-over time when the central application server 102 is down during EOD processing or during occurrence of any abnormal disconnect of the central application server 102.

For promptly serving customers located in different geographical locations, Information Technology (IT) infrastructure of the central application server 102 is connected to IT infrastructure of multiple local branches located at different geographic locations using Wide Area Networks (WANs). IT infrastructure of the central application server 102 acts as a backbone that either serves customers directly or facilitates provision of services to customers of local branches. The central database 110 is operationally connected to databases associated with local branches and shares database structures with the local branches so that customer data can be easily shared between them. The central database 110 may act as a server providing database services to local databases such as replication services, backup services, update services etc.

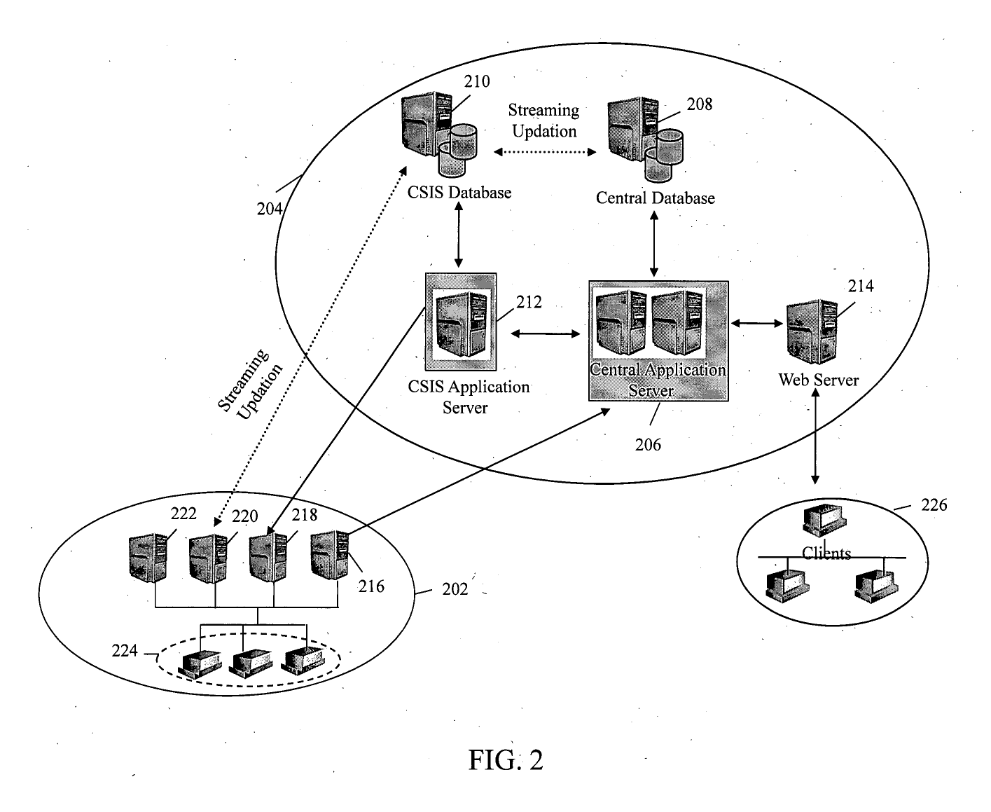

FIG. 2 illustrates interaction of software components deployed at a local branch with central facility of a banking services provider for servicing branch level requests. As shown in the figure a local branch IT system 202 is connected to a central IT system 204 of a banking services provider through a communication network. As described with respect to FIG. 1, the central IT system 204 comprises a central application server 206, a central database 208, a CSIS database 210, a CSIS Application Server 212 and a web server 214. The web server 214 is used by customers or by internal employees of a banking services provider to login to the central IT system 204. In an embodiment of the present invention, the local branch IT system 202 comprises a local web server 216, a Local Stand-in Server (LSIS) 218, branch database 220, a branch application server 222 and one or more clients 224. The branch application server 222 hosts a primary application that services direct customers of the branch.

The branch application server 222 includes business logic for servicing branch application requests when the local branch is in ONLINE mode i.e. connectivity of the local branch IT system 202 to the central application server 206 is intact. The branch application server 222 is also equipped to service branch application requests when the local branch is in OFFLINE mode, i.e. when connectivity to the central application server 206 is unavailable. The branch application server 222 is linked to the branch database 220 and is configured to serve requests received from the one or more clients 224 associated with the branch. In an embodiment of the present invention, the one or more clients 224 are processing devices used by customers of the branch for accessing banking services. In another embodiment of the present invention, the one or more clients 224 are processing devices used by branch employees for processing applications. Requests from the one or more clients 224 are received by the branch application server 222 through the web server 216. During ONLINE mode, the branch application server 222 serves requests from the one or more clients 224 by communicating with the central application server 206. However, during EOD processing, the Central Application Server 206 is brought down (OFFLINE mode) and the Central Application Server 206 hands over control to the CSIS Application Server 212. During EOD processing, since the Central Application Server 212 is unavailable, the branch application server 222 interacts with the CSIS Application Server 212 for servicing requests. For servicing requests; the CSIS Application Server 212 utilizes customer data stored in the CSIS Database 210. In this case, basic service functionalities such as transactions and inquiries are processed. However, advanced requests are not processed. Once EOD processing is completed, the CSIS Database 210 updates the Central Database 208 through SAF replay and hands back control to the Central Application server 206.

In an embodiment of the present invention, during EOD processing, the Central Application Server 206 may go down without a proper handshake i.e. without handing over control to the CSIS Application Server 212. A condition when this can occur is if there is a problem in exchange of messages between the Central Application Server 206 and the CSIS Application Server 212 during transfer of control. In such a scenario, the CSIS Application Server 212 operates in a Risk Limiting Mode (RLM) mode. In RLM mode, each customer transaction is authorized based on risk limit specified for the customer. Once the Central Application Server 206 becomes operational, the CSIS Database 210 updates the Central Database 208 through SAF replay and hands back control to the Central Application server 206.

In various embodiments of the present invention, connectivity between the local branch IT system 202 and the central IT system 204 may be down i.e. connectivity of the local branch IT system 202 with both the central application server 206 and the CSIS application server 212 is unavailable. During such a scenario, the branch application server 222 interacts with LSIS 218 in order to service the requests. LSIS 218 is a standby server, configured to function similar to the CSIS application server 212 (as described in FIG. 1). In an embodiment of the present invention, LSIS 218 maintains data about customers linked to the branch along with their accounts and transactions related to all their accounts. LSIS 218 accepts requests from the one or more clients 224 and services those requests. In an embodiment of the present invention, the LSIS 218 keeps a record of transactions in a Store and Forward (SAF) table. Once connectivity between the local branch IT system 202 and the central IT system 204 is restored, LSIS 218 updates the Central Database 218 through SAF replay and normal operations are resumed, wherein branch requests are served by the central application server 206. If connectivity between the local branch IT system 202 and the central IT system, 204 is inoperative for several days at a stretch, Central Database 208 is updated by SAF database through file uploads. In an embodiment of the present invention, instead of employing LSIS 218, a Flexi Stand-in Server (FSIS) is employed. An FSIS is a standby server that services requests pertaining to multiple local branches when connectivity between the local branches and the central IT system 204 is down. An FSIS database contains data corresponding to a set of branches instead of one branch only. For efficient operation, the branch database 220 is regularly refreshed from the CSIS database 210 in a ‘streamed’ fashion based on frequency set for the branch, when connectivity between the local branch IT system 202 and the central IT system 204 is available. In an exemplary embodiment of the present invention, frequency for a branch is set based on empirical data such as; frequency of network failure for branch, available network bandwidth etc. Updating of branch database 220 from the CSIS Database 210 is achieved using standard data synchronization tools.

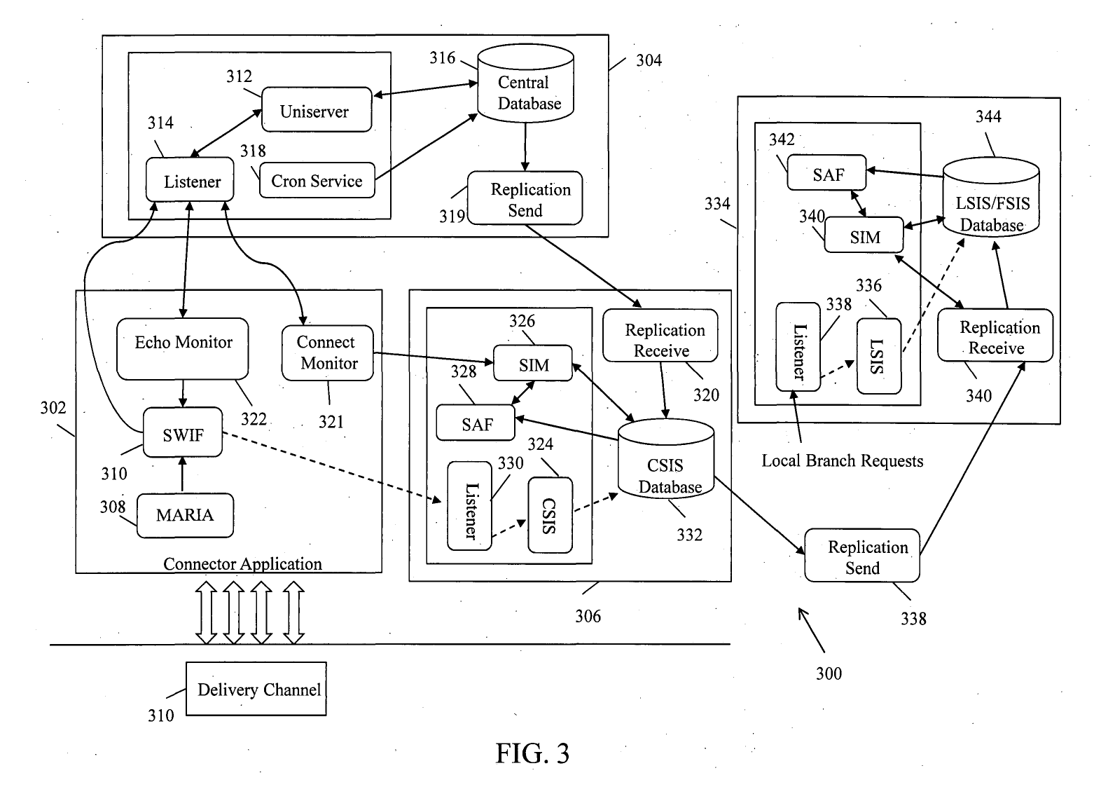

FIG. 3 illustrates messaging between software components of a central facility of a banking services provider and components of IT system of a local branch for providing transaction services. In an embodiment of the present invention, a messaging based architecture is implemented by IT components of banking services provider and a local branch for providing uninterrupted services to customers. Applications executed by components located at central facility and at a local branch include processes such as a listener process that accepts connections from external applications and services the messages, a monitor or controller process that controls number of listener processes needed to service requests based on the load. Each monitor or controller server component can be configured to bring up and maintain a minimum number of listener processes during normal operation. Based on the load, additional listener processes may also be brought up by the monitor process up to a maximum number that can be configured. Typically, each listener process services one connection from a port. As the number of client connections increases, there is a corresponding increase in the number of server processes which are brought up by the monitor process.

As described earlier, with reference to FIG. 1, a connector application acts as middleware between IT infrastructure of a banking services provider and IT components of a local branch. Referring now to FIG. 3, the connector application 302 executes transfer of messages between applications running on a central application server 304 and other components that include delivery channels and applications running on standby servers installed in local branches. Examples of delivery channels include, but are not limited to, electronic customer interfaces such as ATMs, Point of Sale (POS), Internet Banking, integrator application, treasury application etc. In an embodiment of the present invention, listener processes employed by the connector application 302 includes Multiple Asynchronous Request Interface Adapter (MARIA) 308 and Switch Interface (SWIF) 310. MARIA 308 is a generic listener process that lists Delivery Channel Controllers (DCCs) for all types of requests. This process handles connection pooling and queuing of messages from one or more clients. MARIA 308 may receive messages from Delivery Channel 310 in ISO 8583 format requesting access to listener service processes. MARIA distributes load within existing listener service processes on a central application server or a stand-in server and only brings up additional processes if all the running processes are busy. In an embodiment of the present invention, MARIA is configured to implement load balancing in a manner similar to that implemented by the connector application 302, as described earlier with reference to FIG. 1.

SWIF 310 is an application configured to interface the connector application 302 with external systems such as the central application server 304 and a Central Stand-In Server (CSIS) 306. SWIF 310 receives messages relayed to it by MARIA 308 and in turn delivers the messages to Uniserver process 312 at the central application server 304 through a Listener process 314. In case, connectivity to the central application server 304 is down, SWIF 310 delivers messages to the CSIS 306.

Uniserver 312 handles business functionality of messages delivered by the connector application 302. Messages are delivered to Uniserver 312 through SWIF 310. In an exemplary embodiment of the present invention, messages are delivered to Uniserver 312 in an internal data format. Uniserver 312 sends a response to SWIF 310 after processing a transaction based on the message. For processing transactions, the Uniserver 312 utilizes Central Database 316 that includes stored customer transactional data and customer profiles. The central application server 304 also includes a continuously running cron service 318 that keeps contra entry record of cash withdrawals from ATMs. In a real case scenario of cash withdrawal from an ATM when the customer account is debited online, contra entry by the cron service 318 occurs based on pre-defined parameter values. The cron service 318 monitors parameters and creates auto contra entry when pre-configured parameter values are reached.

A critical process running at the central application server 304 is Replication send (Transmit) 319. Transmit 319 identifies records updated or added in information tables in the central application server 304 and sends the information to a listener process in the CSIS 306. The CSIS 306 is a standby server that services requests from delivery channels and other applications in case the central application server 304 is OFFLINE. A Replication receive (Refresh) process 320 at the CSIS 306 listens for messages from the Transmit process 319 and updates respective tables at the CSIS Database 302.

In various embodiments of the present invention, monitor or controller processes implemented by the connector application 302 comprises a Connect Monitor 321 and an Echo Monitor 322. Connect Monitor 321 listens to request sent by Uniserver 312 for maintaining an ONLINE/OFFLINE flag. An ONLINE/OFFLINE flag indicates whether connectivity of the central application server 304 to CSIS 306 is maintained. In an embodiment of the present invention, when connectivity of the central application server 304 to the local branch is active, client requests arriving at central application server 304 are processed by Uniserver 312. Further, all requests at local branches are also relayed to Uniserver 312 to be processed. In an embodiment of the present invention, when the central application server 304 is brought down in a planned manner, such as during EOD processing, the Uniserver 312 sends a message to the Connect Monitor 321 which changes the flag at the connector application 302 to OFFLINE. Consequently, all requests to the connector application 302 are directly routed to the CSIS 306 till an ONLINE message is received from the Uniserver 312. Further, all requests arriving at a local branch application server are also routed to CSIS 306 for processing.

Processes implemented by the CSIS 306 include Central stand-in service 324, Stand-in Monitor (SIM) 326, Store and Forward (SAF) 328 and Listener 330. When flag status at the Connect Monitor 321 is set to OFFLINE, the Connect Monitor 321 sends a message to the SIM 326 indicating the status. SIM 326 is a controller process in CSIS 306 that handles change of status of various processes running in CSIS 306 during EOD or BOD processing. Consequently, messages from the SWIF 310 are routed to Listener process 330 at the CSIS 306 and requests corresponding to the message are serviced by the Central stand-in service 324. The Central stand-in service 324 listens for requests from the SWIF 310 and provides same functionality as the Uniserver 312. It processes requests based on CSIS database 332 and uses application logic similar to the Uniserver 312 for processing requests. CSIS database 332 is periodically refreshed from the Central Database 316 through Transmit process 319 and Refresh process 320. During OFFLINE processing, Echo Monitor 322 in the connector application 302 is configured to process messages that are needed for controlling the SWIF 310 application status. Moreover, Echo Monitor 322 checks for availability of Uniserver 312 at periodic time intervals. Once, the Uniserver 312 becomes ONLINE, the Echo Monitor 322 sends a message to the SWIF 310 specifying the ONLINE status so that customer data between the central application server 304 and the CSIS 306 can be shared.

SAF 328 is a service which maintains an SAF table storing customer transaction data during OFFLINE processing, when requests are processed by CSIS 324. For example, the SAF table stores, messages processed by CSIS 324. During OFFLINE processing, Connect Monitor 321 polls for availability of the Uniserver 312. Once Connect Monitor 321 gets a response from the Uniserver 312, it sends a message to SIM 326 to play messages stored by SAF process 328. SAF replay is a process which is invoked when connectivity between the central application server 304 and local branch is restored. In an embodiment of the present invention, SIM 326 provides a service to monitor status of SAF replay by checking the SAF table. Upon receiving ONLINE message from Connect Monitor 321, SIM 326 initiates the SAF replay process. SAF replay process updates Uniserver 312 with details stored in the SAF table, which in turn are stored at Central Database 316. In an embodiment of the present invention, the SAF replay process is also initiated when an unscheduled shutdown of the central application server 304 occurs. During such an occurrence, CSIS 306 operates in RLM mode and all services requested through the connector application 302 or through client computers at local branches are serviced by the CSIS 306.

The figure also illustrates processes run at a Local Stand-in Server 334 which is installed at a local branch for servicing branch level requests. The local stand-in server 334 services branch level requests when connectivity between the central application server 304 and the local branch is unavailable and also when the CSIS 306 is unavailable. In an embodiment of the present invention, instead of a local stand-in server 334, a flexi stand-in server may be deployed which is configured to service requests for a group of branches. Processes run at the Local Stand-in Server 334 include local stand-in service 336, listener process 338, a Stand-in Monitor (SIM) 340 and a Store and Forward (SAF) service 342. SIM 340 is a controller process in local stand-in server 334 that handles change of status of various processes running when the connectivity between local branch and the central application server 304 or the local branch and the CSIS 306 is unavailable. Local branch requests arriving at a branch application server are processed by the local stand-in service 336 using customer data located in an LSIS Database 344. For facilitating serving of requests by the Local Stand-in Server 334, an LSIS/FSIS Database 344 is regularly refreshed by the CSIS Database 332 through Replication Send service 338 and a replication receive service 340, when connectivity between local branch and the central application server 304 is active. SIM 340 monitors SAF table maintained by the SAF process 342 Once connectivity between the Local Stand-in Server 334 and the central application server 304 is restored, SIM 340 initiates SAF replay process.

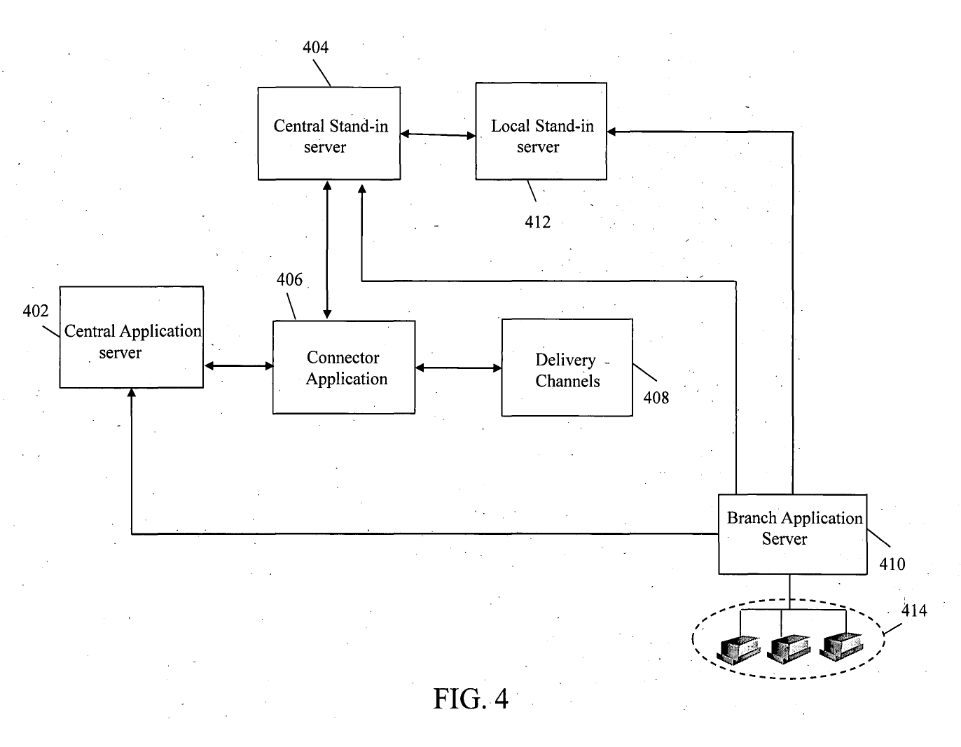

FIG. 4 illustrates implementation of various modes of operation by a banking system 400 for servicing transaction requests, in accordance with an embodiment of the present invention. The banking system 400 includes various modules at a′central facility of a banking services provider and at a local branch that operate in various operational modes in order to provide uninterrupted services to customers. The modules at the central facility include a central application server 402, a central stand-in server 404 and a connector application 406. The central stand-in server 404 operates either in NORMAL mode or in RISK LIMIT mode. In NORMAL mode, central application server 402 hands over control to Central Stand-in server 404 in a planned manner. A typical scenario when this would happen is during End of Day (EOD) processing or when the central application server 402 is brought down for maintenance purposes. In NORMAL mode, central stand-in server 404 functions similar to the central application server 402 but for a few exceptions. The central stand-in server 404 will accept requests from Delivery channels 408 through the Connector application 406. The central application server 404 will also accept requests from client computers installed at the central facility and from a branch application server 410. The branch application server 410 is the primary application server at the local branch which is operationally connected to both the central application server 402 and the central stand-in server 404.

In various embodiment of the present invention, a local stand-in server 412 is installed at a local branch to service branch application requests when connectivity between local branch and the central application server 402 or between the local branch and the central stand-in server 404 is unavailable. The local stand-in server 412 employs a continuously running process that listens to transaction requests. Transaction requests can be requests from one or more clients 414 that come directly to the branch application server 410. Transaction requests may also be received from Delivery Channels 410 through a connector application 404. Handling of messages from the branch application server 410 may differ from that of Delivery Channels 408. In an embodiment of the present invention, the local stand-in server 412 accepts messages only in internal application-required format. In various embodiments of the present invention, a Flexi Stand-in server (not shown in the figure), that is configured to service requests pertaining to multiple local branches handles transaction requests when connectivity between one or more of the multiple branches and the central application server 402 or between the one or more of the multiple branches and the central stand-in server 404 is unavailable.

The local stand-in server 412 is provided with complete and accurate information of customer account balances and transactions from Central stand-in server 404 and can authorize transaction requests based on account data available. In an embodiment of the present invention, if a request is an inquiry message, suitable details are extracted from a branch database, formatted accordingly and provided. In another embodiment of the present invention, if the message is a transaction request, i.e. a message that has financial implications, a transaction will be created and executed. Account balances corresponding to, customer transactions will be reflected accordingly. In yet another embodiment of the present invention, if the message if of request type (for example, a chequebook request) the message will be stored in SAF table and will not be processed. All messages processed by local stand-in server 412 will be stored in an SAF table. The stored messages would be transmitted to the central application server 402 when connectivity is restored. Actual transaction creation/processing of unprocessed messages will be done by the central application server 402 after receipt of SAF replay. Since the unprocessed messages are already authorized by the local stand-in server 412, the messages will be sent as advises as part of SAF replay. A category of messages that would not be processed by the local stand-in server 412 includes reversal of messages, in case the original message is not found. In an exemplary embodiment, if an original message is not found for the reversal message, the message won't be created in the local stand-in-server 412. However, an entry would be made in SAF table for replaying to the central application server 402. Handling of reversal will then be taken care at central application server 402.

In various embodiments of the present invention, the central application server 402 is unable to pass control in a planned manner to the central stand-in server 404. Possible scenarios when this can happen is if there is a problem with connectivity between the connector application 406 and the central application server 402, if the central application server 402 does not respond to the connector application 406 due to some reason or due to improper transfer of control from the central application server 402 to the connector application 406. Further, Uniserver processing of the central application server 402 may become unavailable suddenly due to problems in communication links, hardware or database problems. In such scenarios, the connector application 406 is configured to switch to local stand-in server 412 for transaction authorizations. Under the aforementioned conditions, the local stand-in server 412 operates in RLM mode. In RLM mode of operation, the local stand-in server 412 uses a risk limiting logic to authorize transactions. Each customer transaction gets authorized by the local stand-in server 412 based on a risk limit specified for the customer. Risk limit is the maximum risk a banking services provider is willing to undertake on behalf of a customer and maximum amount that is allowed to be withdrawn by the customer in case actual balance from the central application server 402 is not available. In various embodiments of the present invention, risk limit for each customer is established at the central application server 402 when a customer account is created. Risk limit value is refreshed on the local stand-in server 412 whenever a new customer is added or if any updates happen on the customer debit limit. Risk limit or a Cumulative customer debit offline limit is applied to reduce risk to the banking service provider. Risk Limit or Customer Debit Offline Limit is total “net exposure” that the banking service provider can take for the customer without knowing his/her correct balance accurately. In an embodiment of the present invention, Customer Debit offline limit value can be set as part of a customer maintenance screen.

Once risk limit for a customer has been specified and a new transaction request arrives at the local stand-in server 412, the local Stand-in server 412 ensures that, sum total of all transactions across all accounts of a particular customer cannot exceed the risk limit. For example, if a customer has two accounts with the last known available balance being 20,000 INR and the risk limit specified is 7500 INR, the customer can withdraw only a maximum of only 7500 INR during the period when the local stand-in server 412 is in RLM mode. However, available balance of a particular customer changes with processing of transactions by the local stand-in server 412. Hence, during processing of a particular transaction, if last known available balance for a customer account associated with a current transaction is less than the specified risk limit, then instead of the risk limit value, the effective available balance becomes the withdrawal limit for the customer.

In an exemplary embodiment of the present invention, for validating financial transaction associated with a customer in RLM mode following steps are implemented by the local stand-in server 412 in real time: Firstly, available balance in customer account associated with the requested transaction is calculated by the equation:

Available Balance=Last Known Available Balance from central application server−(Account Balance resulting from transactions associated with the particular account including credit transactions and debit transactions executed by Stand-in server in RLM mode and also taking into account Blocks and Unblocks in SAF table) (1)

Blocks indicate transaction amounts blocked for processing, for example, blocking amounts for instrument clearing transaction for which confirmation for clearing is pending, whereas unblocks indicate lifting of blocked amount or clearing the amount for processing. In an embodiment of the present invention, last known available balance is accessible in one of database tables of the local stand-in server 412 since local database at the local stand-in server 412 is periodically refreshed from central database whenever there is change in account balance at the central application server 402. After ascertaining “Available Balance”, it is checked whether “Current Transaction Amount” is less than “Available Balance”. In case it is determined that “Current Transaction Amount” is greater than “Available Balance”, the transaction is rejected.

However, if it is determined that “Current Transaction Amount” is less than “Available Balance”, total amount associated with transactions for all customer accounts that have been completed in RLM mode is determined using the following equation:

Total amount associated with transactions=Current transaction amount+(Account Balance resulting from transactions in all customer accounts including credit transactions, debit transactions executed by Stand-in server in RLM taking into account Blocks and Unblocks in SAF table) (2)

In case total amount associated with the transactions is less than Risk Limit value or Offline Debit Limit value of the customer, the transaction is allowed, otherwise it is rejected. A script hook may be provided in business logic implemented by the Stand-in server to define a custom logic in arriving at available balance in RLM mode.

In various embodiments, system of the present invention is configured to switch back to NORMAL mode of operation, as soon as connectivity between local branch and the central application server 402 is restored. During RLM mode of operation a daemon (Monitor) program running in primary application of local stand-in server 412 constantly polls the central application server 402 for access to Uniserver process. Once availability of Uniserver process is determined, the primary application automatically replays accumulated data in the SAF table into the central application server 402. Further, before processing any request, the connector application 406 first tries to get authorization from Uniserver before sending any message to the local stand-in server 412. This ensures that as soon as Uniserver operations resume, authorization is provided by the central application server 402 instead of the local Stand-in server 412 in RLM mode.

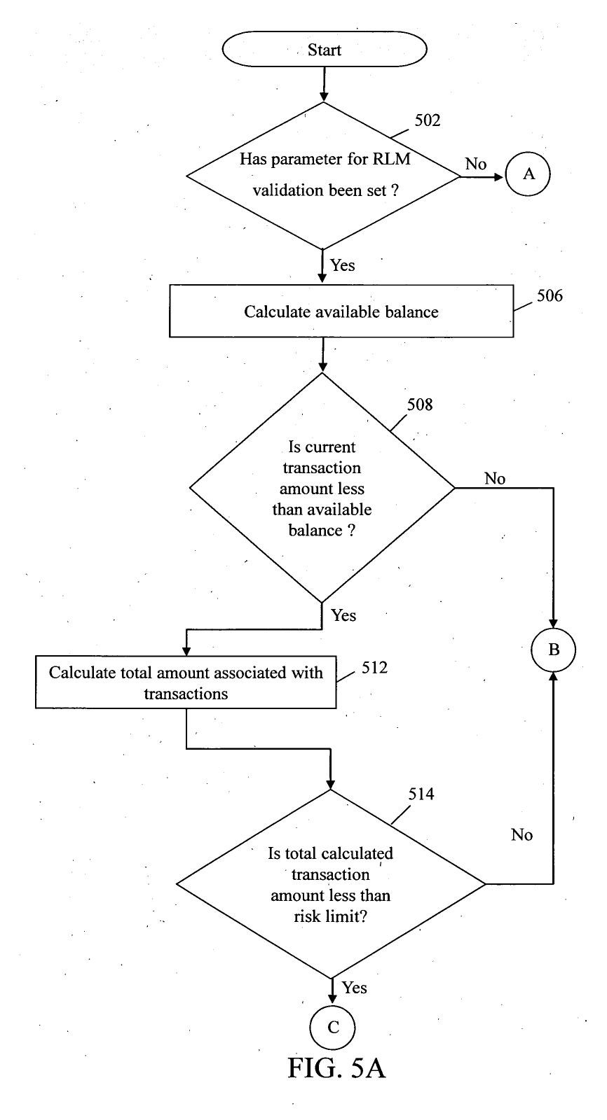

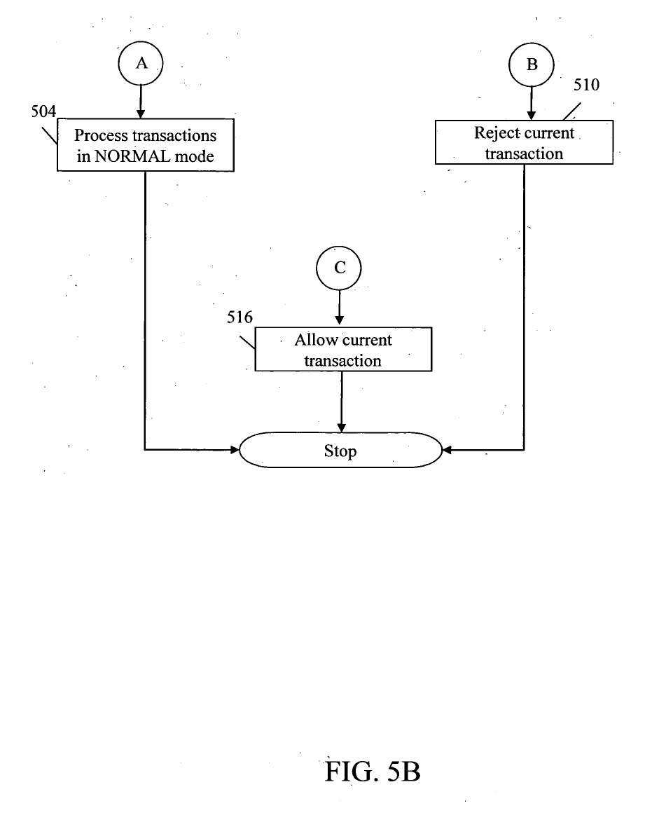

FIGS. 5A and 5B illustrates method steps for processing a transaction request in risk limit mode. In an embodiment of the present invention, transactions may be processed in risk limit mode by a central stand-in server when central application server is not able to hand over control for processing transactions to the central stand-in server, such as during an abrupt shutdown of the central application server. In another embodiment of the present invention, a local stand-in server at a local branch may operate in risk limit mode when connectivity of the local branch to either the central application server or the central stand-in server is unavailable. At step 502, it is determined whether parameter for RLM validation has been set by a system administrator. If it is determined that RLM validation parameter has not been set, then at step 504, central stand-in server processes transactions in NORMAL mode. However, if it is determined that RLM validation parameter has been set, transactions are processed in RISK LIMIT MODE using specific OFFLINE limits set for individual customers. At step 506, available balance in customer account associated with current transaction is calculated. In an embodiment of the present invention, a customer may hold one or more accounts, but a current transaction request is associated with one customer account. Therefore, balance available with associated customer account is calculated by system of the invention and is then compared with current transaction amount. At step 508, it is determined whether current transaction amount is less than the available balance.

If it is determined that the transaction amount is more than the available balance, then at step 510, the transaction is rejected. However, if it is determined that the transaction amount is less than the total available balance, then at step 512 total amount associated with transactions already executed in RLM mode and including the current transaction amount (hereinafter referred to as total calculated transaction amount) is determined. In an embodiment of the present invention, the total calculated transaction amount is determined by taking into account credit transactions and debit transactions executed in RLM mode in all customer accounts and by considering transaction blocks and unblocks specified in SAF table. Once the total calculated transaction amount is determined, at step 514 it is ascertained whether total calculated transaction amount is less than a pre-defined risk limit for the customer. If the total calculated transaction amount is less than the risk limit, then at step 516 the transaction is allowed, otherwise the transaction is rejected.

The method and system for limiting risk in banking transactions as described in the present invention or any of the embodiments, may be realized in the form of a computer system. Typical examples of a computer system include a general-purpose computer, a programmed microprocessor, a micro-controller, a peripheral integrated circuit element, and other devices or arrangement of devices that are capable of implementing the steps that constitute the method of the present invention.

The computer system typically comprises a computer, an input device, and a display unit. The computer typically comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions on the computer system.

The computer system executes a set of instructions that are stored in one or more storage elements to process input data. The storage elements may also hold data or other information, as desired, and may be an information source or physical memory element present in the processing machine. The set of instructions may include various commands that instruct the processing machine to execute specific tasks such as the steps constituting the method of the present invention.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A system for providing banking solutions by limiting risk in provision of one or more banking services to customers of a banking services provider, the system comprising:
a central application server installed at central facility of the banking services provider, the central application server comprising a primary software application configured to provide the one or more banking services to direct customers of the central facility and to customers of one or more local branches, wherein the primary software application comprises executable files having business logic for running one or more software processes for provisioning the one or more banking services;
a central stand-in server configured to provision the one or more banking services to customers during End of Day processing, wherein the central application server transfers control to the central stand-in server during End of Day processing;
a web server configured to enable customers of the banking services provider to access the one or more banking services through the central application server;
a connector application configured to interface the central application server with a plurality of delivery channels and a plurality of electronic applications; and
one or more local stand-in servers installed at the one or more local branches for provisioning the one or more banking services to customers of the one or more local branches when connectivity between the one or more local branches and the central application server and between the one or more local branches and the central stand-in server is unavailable, wherein the one or more local stand-in servers provide the one or more banking services by implementing risk limiting logic, further wherein risk limiting logic is implemented by utilizing an allocated risk limit value corresponding to each customer while authorizing banking transactions.

2. The system of claim 1 further comprising an integrator module configured to operate as a transaction gateway for integrating primary software application of the central application server with one or more value-added services.

3. The system of claim 2, wherein the one or more value-added services comprises interne banking, mobile banking, real-time advisement services, audio/video customer support, co-browsing services, alert notification services and customer relationship management services.

4. The system of claim 1, wherein the central stand-in server is further configured to provide the one or more banking services to customers by utilizing risk limiting logic, when connectivity between the central application server and the central stand-in server is disrupted without proper handover form the central application server to the central stand-in server.

5. The system of claim 4 further comprising:
a central database configured to store customer data including customer transactional data and customer profile data; and
a central stand-in server database configured to store copy of customer transactional data and customer profile data continuously updated by automatic streaming, wherein the central stand-in server utilizes the central stand-in server database for processing transactions during risk limit mode.

6. The system of claim 5, wherein each local branch comprises:
a branch application server hosting a primary application configured to service direct customers of the branch;
a branch database operationally linked to the branch application server and comprising customer data pertaining to the local branch, wherein the branch database is regularly refreshed from the central stand-in server database; and
a local stand-in server configured to operate in a risk limit mode for servicing local branch requests when connectivity between the local branch and the central application server is unavailable.

7. The system of claim 1 further comprising a flexi stand-in server in lieu of the one or more local stand-in servers for servicing requests pertaining to the one or more local branches.

8. The system of claim 1, wherein the one or more software processes implemented by the central application server comprises:
a uniserver process configured to manage business functionality of messages delivered by one or more of the plurality of delivery channels and the plurality of electronic applications to the central application server;
a listener process configured to accept connections from processes running in the central stand-in server and the one or more local stand-in servers;
a cron service configured to keep a contra entry record of cash amount withdrawals from ATMs and point of sale terminals and continuously providing updated information to a central database of the central application server; and
a replication send service that identifies records updated or added in the central database and provides the information to a listener process in the central stand-in server.

9. The system of claim 8, wherein the connector application implements one or more software processes for providing a real-time interface to the central application server, further wherein the one or more software processes comprises:
an asynchronous request interface adapter that manages connection pooling and queuing of messages from the plurality of delivery channels;
a switch interface configured to receive messages relayed through the asynchronous request interface adapter and further configured to deliver the messages to the uniserver process of the central application server;
a connect monitor process configured to listen to request sent by uniserver for maintaining status flag indicating connectivity of central application server with the central stand-in server; and
an echo monitor process configured to check for availability of uniserver process at periodic time intervals and further configured to process messages needed to control switch interface status.

10. The system of claim 9, wherein each stand-in server implements one or more software processes, wherein the one or more software processes comprises:
a central stand-in service configured to listen for request from the switch interface and manage business functionality of messages delivered by one or more of the plurality of delivery, channels and the plurality of electronic applications;
a replication receive process configured to listen for messages from the replication send service and update information tables in stand-in server database;
a stand-in monitor process configured to manage change of status of various processes running in the stand-in server during End of Day processing; and
a store and forward process configured to maintain a table storing customer transaction data for requests processed by the stand-in server and further configured to, update the Uniserver with customer transaction data when connectivity between the stand-in server and the central application server is restored, wherein the connect monitor process is configured to activate the initiation of updation process of Uniserver by sending a message to the stand-in monitor process.

11. A method for providing banking solutions to customers of banking services provider by limiting risk in provision of one or more banking services, the method comprising:
calculating available balance in customer account associated with current transaction;
determining if current transaction amount is less than the available balance;
calculating total amount associated with transactions for a plurality of customer accounts executed in risk limit mode, if the current transaction amount is less than the available balance, wherein the total calculated transaction amount includes current transaction amount;
determining if total calculated transaction amount is less than a pre-determined risk limit value pre-defined for a customer; and
allowing current transaction if total calculated transaction amount is less than the pre-defined risk limit value.

12. The method of claim 11 further comprising rejecting current transaction if the current transaction amount is more than available balance in customer account associated with current transaction.

13. The method of claim 11 further comprising rejecting current transaction if the total calculated transaction amount is more than the pre-determined risk limit value.

14. A method for providing banking solutions to customers of banking services provider by limiting risk in provision of one or more banking services, the method comprising:
determining whether parameter for risk limit mode validation has been set;
calculating available balance in customer account associated with current transaction, if risk limit mode validation parameter is set;
determining if current transaction amount is less than the available balance;
calculating total amount associated with transactions executed in risk limit mode, if the current transaction amount is less than the available balance, wherein total calculated transaction amount includes current transaction amount;
determining if total calculated transaction amount is less than a pre-determined risk limit value pre-defined for a customer; and
allowing current transaction if total calculated transaction amount is less than the pre-determined risk limit value.

15. The method of claim 14 further comprising processing current transaction in NORMAL mode if it is determined that parameter for risk limit mode validation has not been set.

16. The method of claim 14 further comprising rejecting current transaction if the current transaction amount is more than available balance in customer account associated with current transaction.

17. The method of claim 14 further comprising rejecting current transaction if the total calculated transaction amount is more than the pre-determined risk limit value.
